(19) United States
(12) Patent Application Publication
(10) Pub. No.: US 2009/0128419 A1
(43) Pub. Date: May 21, 2009

(54) MULTI-FREQUENCY ANTENNA

(75) Inventors: Yi-Wei Tseng, Taipei County (TW); Tsung-Wen Chiu, Taipei County (TW); Fu-Ren Hsiao, Taipei County (TW); Sheng-Chih Lin, Taipei County (TW)

Correspondence Address: SCHMEISER OLSEN & WATTS, 18 E UNIVERSITY DRIVE, SUITE # 101, MESA, AZ, 85201, US

(73) Assignee: ADVANCED CONNECTEK INC., Taipei County (TW)

(21) Appl. No.: 12/192,545

(22) Filed: Aug. 15, 2008

(30) Foreign Application Priority Data
Nov. 16, 2007 (TW) 096143413

(51) Int. Cl. H01Q 5/00; H01Q 9/04

(52) U.S. Cl. 343/700 MS

(57) ABSTRACT

The present invention discloses a multi-frequency antenna, which comprises a radiation conductor, a parasitic conductor, a feeder cable and a ground plane. The radiation conductor comprises a feeder member, a first radiation arm and a second radiation arm. The feeder cable comprises a central cable and an outer cable. The feeder member has a coupling side. The parasitic conductor is connected with the ground plane and has a coupling side arranged along the contour of the coupling side of the feeder member. The coupling side of the parasitic conductor and the coupling side of the feeder member have a gap there between. The first and second radiation arms excite a low-frequency resonant mode, and the parasitic conductor excites a high-frequency mode. Therefore, the multi-frequency antenna of the present invention not only covers several operational frequency bands and has a UWB feature, but also has a simplified structure.

### BACKGROUND OF THE INVENTION

1. Field of the Invention

The present invention relates to a multi-frequency antenna, particularly to an antenna system incorporating a UWB technology.

2. Description of the Related Art

With popularization of wireless communication, the lightweight, small-size, high-receiving capability, and low-cost antenna is going to be the mainstream of the market. The dual-band antenna is a miniature antenna having two resonant frequencies despite its limited size. The conventional dual-band antenna usually integrates two or more types of antennae. For example, a U.S. Pat. No. 6,204,819 disclosed a dual-band antenna structure, which integrates a planar inverted-F antenna and a loop antenna, and which switches between two antennae to receive different feed-in signals via the operation of a switch device. However, the prior-art antenna is bulky and hard to layout. Further, it needs a chip to switch the operational frequency bands. Therefore, the prior-art antenna has a complicated circuit and a high fabrication cost.

Refer to FIG. 1 a front view of a “Dual-Band Antenna” disclosed by a U.S. Pat. No. 7,180,463. The prior-art antenna is printed on a substrate 11 and comprises a signal feed-in element 12, an impedance element 13, a first transmitting element 14, a first feed-in point 141, a second transmitting element 15, a second feed-in point 151 , and a ground point 17. The signal feed-in element 12 is electrically coupled to the first feed-in point 141 and the second feed-in point 151, and respectively provides ¼-wavelength resonant cavities for them in cooperation with the ground point 17. The first transmitting element 14 is coupled to the signal feed-in element 12 via the first feed-in point 141 and used to transmit a high frequency signal. The second transmitting element 15 is coupled to the signal feed-in element 12 via the second feed-in point 151 and used to transmit a low frequency signal.

Refer to FIG. 2 a diagram showing the measurement results of the return loss of the “Dual-Band Antenna” disclosed by the U.S. Pat. No. 7,180,463. From FIG. 2, it is known that the mean return loss of the system is below −10 db at the system operational frequency bands of 2.4-2.5 GHz and 4.3-6 GHz. Therefore, the operational frequency bands of the system completely cover the operational frequency bands of IEEE802.11a and 802.11b.

In the abovementioned “Dual-Band Antenna”, the sending end of the second transmitting element 15 is bent into an “L” shape to increase the area of the sending end and increase the transmitting bandwidth. However, such a design increases the length and size of the antenna conductor. For modulating the impedance matching of the first transmitting element 14, a support element 16 is arranged opposite to the second transmitting element 15 across the first transmitting element 14. The support element 16 and the first transmitting element 14 are parallel to each other and have a gap therebetween to form a capacitive load. However, such a design results in a complicated antenna structure. Further, the support element 16 is hard to be positioned precisely.

### SUMMARY OF THE INVENTION

The primary objective of the present invention is to provide a multi-frequency antenna, wherein a first radiation arm and a second radiation arm are used to excite a low-frequency resonant mode, and a parasitic conductor is used to excite a high-frequency resonant mode, whereby the antenna system covers several operational frequency bands and has a UWB (Ultra-Wide Band) feature, and whereby the present invention overcomes the conventional problem that a miniature antenna cannot have a greater bandwidth.

Another objective of the present invention is to provide a multi-frequency antenna, wherein the radiation conductor and the parasitic conductor have a simple configuration, whereby the layout of the antenna requires much less space, and whereby the antenna is easy to layout and easy to assemble, and whereby the fabrication cost is reduced.

To achieve the abovementioned objectives, the present invention proposes a multi-frequency antenna, which comprises a ground plane, a radiation conductor, a parasitic conductor and a feeder cable. The radiation conductor further comprises a feeder member, a first radiation arm and a second radiation arm. The feeder cable further comprises a central cable and an outer cable. The feeder member has a first coupling side. The first radiation arm is connected with the feeder member and extends from the feeder member along a direction. The second radiation arm is connected with the feeder member and extends from the feeder member along another direction opposite to the direction along which the first radiation arm extends. The parasitic conductor is connected with the ground plane and has a second coupling side arranged along the contour of the first coupling side of the feeder member. The first coupling side of the feeder member and the second coupling side of the parasitic conductor have a gap therebetween. The central cable is connected with the feeder member, and the outer cable is connected to the ground plane.

The first radiation arm and the second radiation arm extending oppositely are used to excite a low-frequency resonant mode of the antenna system. The first radiation arm and the second radiation arm have an identical length and can be finely tuned to have a two-stage resonant mode and increase the bandwidth of the low-frequency resonant mode. The parasitic conductor extending to the ground plane is used to excite a high-frequency resonant mode. The low-frequency resonant mode and the high-frequency resonant mode are integrated into a UWB mode, which makes the antenna system able to cover several operational frequency bands and have a wideband feature at the same time. Thus, the present invention features a UWB capability to solve the problem that the conventional miniature antenna is hard to cover several frequency bands. Further, the radiation conductor and the parasitic conductor have a simple configuration. Thus, the antenna has a much smaller volume, and the layout of the antenna requires much less space. Therefore, the multi-frequency antenna of the present invention is easy-to-layout and easy-to-assemble for various electronic devices, and the fabrication cost thereof is also reduced.

Below are described in detail the embodiments to make the present invention easily understood.

### BRIEF DESCRIPTION OF THE DRAWINGS

FIG. 1 is a front view of a “Dual-Band Antenna” disclosed by a U.S. Pat. No. 7,180,463;

FIG. 2 is a diagram showing the measurement results of the return loss of the “Dual-Band Antenna” disclosed by the U.S. Pat. No. 7,180,463;

FIG. 3 is a front view of a multi-frequency antenna according to a first embodiment of the present invention;

FIG. 4 is a front view of a multi-frequency antenna according to a second embodiment of the present invention;

FIG. 5 is a front view of a multi-frequency antenna according to a third embodiment of the present invention;

FIG. 6 is a diagram showing the measurement results of the voltage standing wave ratio of a multi-frequency antenna according to the present invention; and

FIG. 7 is a perspective view showing that the multi-frequency antenna of the present invention is applied to a portable computer.

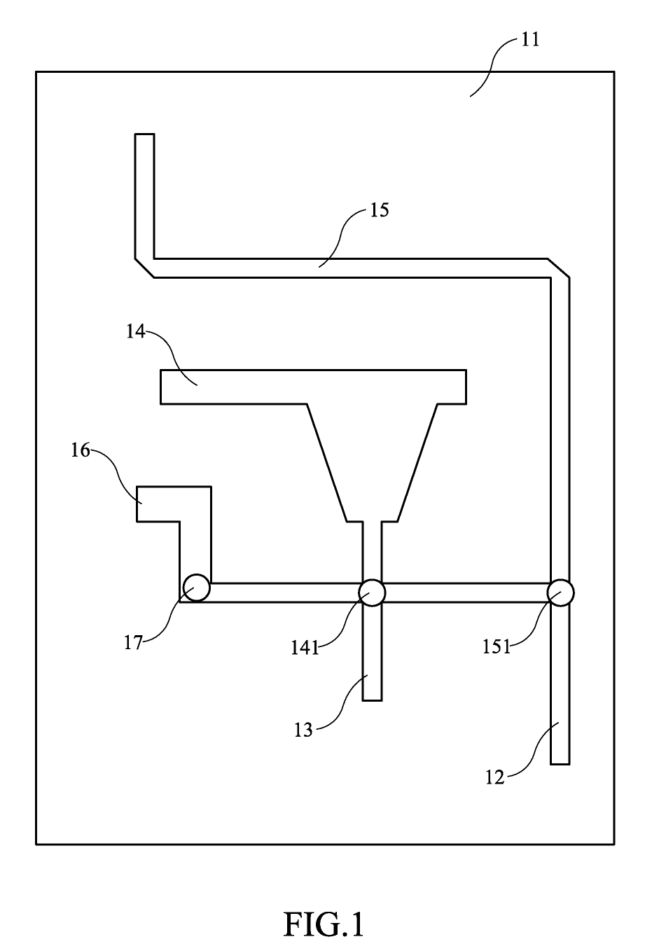

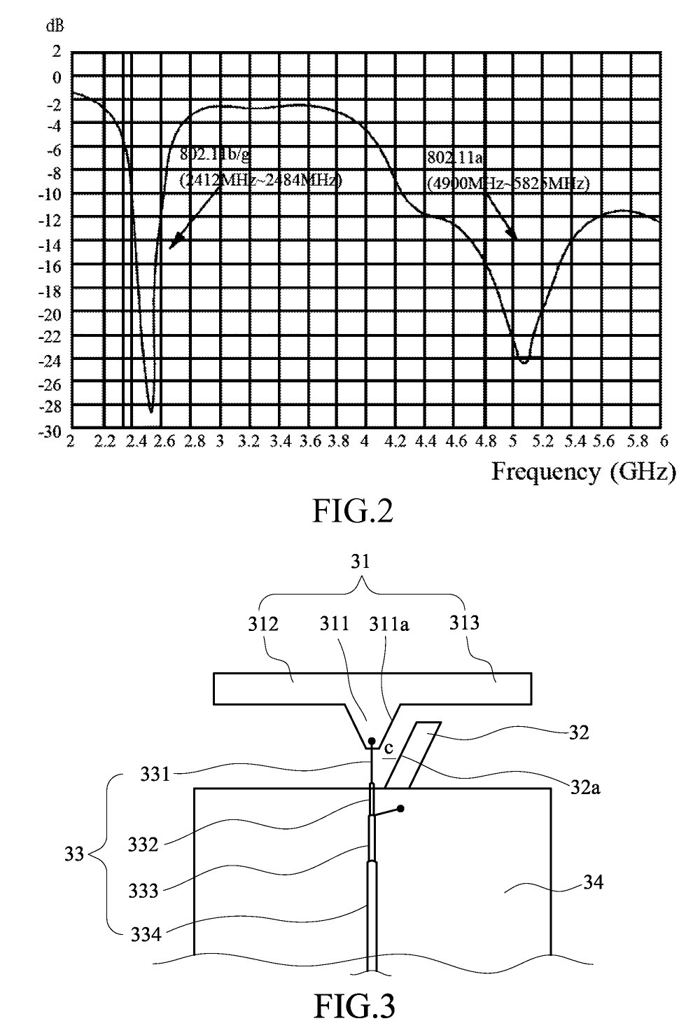

### DETAILED DESCRIPTION OF THE INVENTION

Refer to FIG. 3 a front view of a multi-frequency antenna according to a first embodiment of the present invention. The multi-frequency antenna of the present invention comprises a radiation conductor 31, a parasitic conductor 32, a feeder cable 33 and a ground plane 34. The radiation conductor 31 further comprises a feeder member 311, a first radiation arm 312 and a second radiation arm 313. The feeder cable 33 further comprises a central cable 331, an insulation layer 332, an outer cable 333 and a coating layer 334.

The feeder member 311 has a first coupling side 311a. The first radiation arm 312 is connected with the feeder member 311 and extends from the feeder member 311 along a direction. The second radiation arm 313 is connected with the feeder member 311 and extends from the feeder member 311 along another direction opposite to the direction along which the first radiation arm 312 extends. The parasitic conductor 32 is connected with the ground plane 34. The parasitic conductor 32 has a second coupling side 32a arranged along the contour of the first coupling side 311a of the feeder member 311. The first coupling side 311a of the feeder member 311 and the second coupling side 32a of the parasitic conductor 32 have a gap C therebetween to create a capacitive coupling effect, which can increase the radiation transmission efficiency of the parasitic conductor 32. The central cable 331 is connected with a third side of the feeder member 311 and transmits the high-frequency signal of the feeder cable 33 to the feeder member 311. The outer cable is connected to the ground plane 34.

The feeder member 311 of the radiation conductor 31 has a trapezoid shape with an upper side of about 6 mm, a lower side of about 1 mm and a height of about 1.5 mm. Each of the first radiation arm 312 and the second radiation arm 312 has a length of about 15 mm and a width of about 1.5 mm. In this embodiment, the parasitic conductor 32 has a parallelogram shape with a height of about 3 mm, and an upper side and a lower side both of about 1 mm.

In this embodiment, the first radiation arm 312 and the second radiation arm 313 extending oppositely are used to excite a low-frequency resonant mode of the antenna system. The first radiation arm 312 and the second radiation arm 313 have an identical length, and the low-frequency resonant mode can have a second-order resonance via fine tuning to increase the bandwidth thereof. The parasitic conductor extending to the ground plane 34 is used to excite a high-frequency resonant mode. The low-frequency resonant mode and the high-frequency resonant mode are integrated into a UWB mode, which makes the antenna system cover several operational frequency bands and have a wideband feature at the same time. The multi-frequency antenna of the present invention incorporates the frequency bands of from 2.3 GHz to 6 GHz. Thus, the present invention features a UWB capability and can solve the conventional problem that a miniature antenna is hard to cover several frequency bands. The conventional wireless communication technology has to continuously send out electromagnetic wave. However, the UWB technology needn't send out electromagnetic wave unless there is data being sent out. Therefore, the UWB technology can effectively reduce power consumption and can power-efficiently transmit massive audio/video data. Further, the radiation conductor 31 and the parasitic conductor 32 have a simple configuration. Thus, the antenna has a much smaller size, and the layout of the antenna requires much less space. Consequently, the antenna is easy to layout and easy to assemble, and the fabrication cost is reduced.

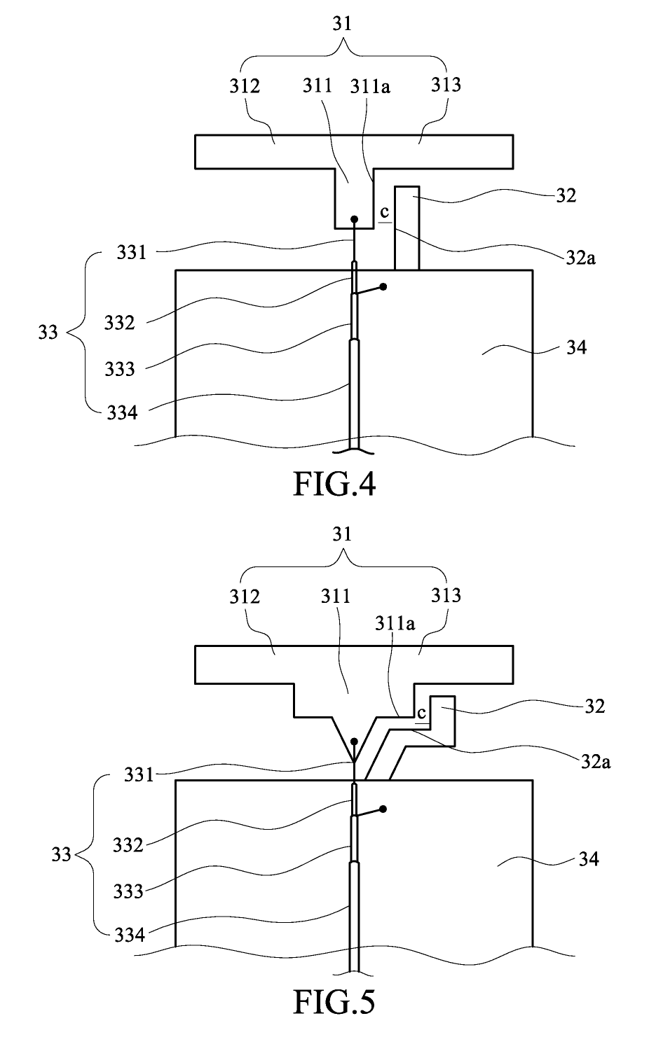

Refer to FIG. 4 a front view of a multi-frequency antenna according to a second embodiment of the present invention. The second embodiment is basically similar to the first embodiment except either of the feeder member 311 and the parasitic conductor 32 has a rectangular shape in the second embodiment. In the second embodiment, the first coupling side 311a of the feeder member 311 and the second coupling side 32a of the parasitic conductor 32 are also parallel to each other and have a gap C therebetween to create a capacitive coupling effect, which can increase the radiation transmission efficiency of the parasitic conductor 32.

Refer to FIG. 5 a front view of a multi-frequency antenna according to a third embodiment of the present invention. The third embodiment is basically similar to the first embodiment except either of the feeder member 311 and the parasitic conductor 32 has a stepped contour in the third embodiment. Similarly, the stepped first coupling side 311a of the feeder member 311 and the stepped second coupling side 32a of the parasitic conductor 32 are also parallel to each other and have a gap C therebetween to create a capacitive coupling effect, which can increase the radiation transmission efficiency of the parasitic conductor 32.

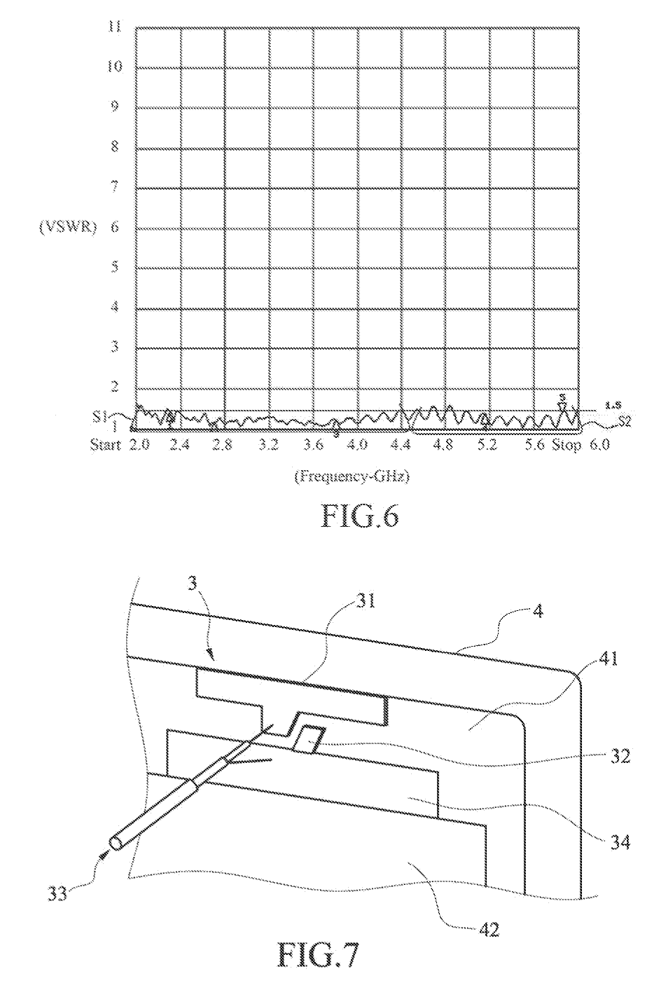

Refer to FIG. 6 a diagram showing the measurement results of the voltage standing wave ratio of the multi-frequency antenna according to the present invention. When a low-frequency operational bandwidth S1 and a high-frequency operational bandwidth S2 are defined by a voltage standing wave ratio of 2, the operational frequency band of the antenna of the present invention ranges from 2.3 GHz to 6 GHz, which covers the frequency bands of the following systems:

(1) WiMAX (2.3 GHz-2.7 GHz)

(2) WLAN802.11b/g (2.4 GHz-2.5 GHz)

(3) UWB (3.1 GHz-4.9 GHz)

(4) WLAN802.11a (4.9 GHz-5.9 GHz)

As shown in FIG. 6, the voltage standing wave ratios are basically below 1.5, which means that the multi-frequency antenna of the present invention indeed possesses the superior properties of the UWB technology and has a wider range of the operational frequency band than the conventional dual-frequency antennae. Besides, the multi-frequency antenna of the present invention has a simple structure, which benefits miniaturizing the antenna system.

Refer to FIG. 7 a perspective view showing that the multi-frequency antenna of the present invention is applied to a portable computer. The multi-frequency antenna 3 of the present invention is arranged near the edge of a chassis 41 of a portable computer 4. A tin foil is used as the ground plane 34 and stuck to the chassis 41, and a screen 42 is arranged inside the chassis 41. The chassis 41 functions as the ground plane of the entire multi-frequency antenna 3; the tin foil transfers the ground signals to the chassis 41. In the application of the present invention, the configuration of the radiation conductor 31 and the parasitic conductor 32 simplifies the antenna structure and reduces the antenna's size. Therefore, the multi-frequency antenna of the present invention is easy-to-layout and easy-to-assemble for various electronic devices.

From the above description, it is known that the present invention possesses utility, novelty and non-obviousness and meets the conditions for a patent. However, it is to be noted that the embodiments described above are only to exemplify the present invention but not to limit the scope of the present invention. Therefore, any equivalent modification or variation according to the spirit of the present invention is to be also included within the scope of the present invention.

What is claimed is:

1. A multi-frequency antenna comprising
a ground plane;
a radiation conductor further comprising
a feeder member having a coupling side,
a first radiation arm connected with said feeder member and extending from said feeder member along a direction, and
a second radiation arm connected with said feeder member and extending said feeder member along another direction opposite to said direction along which said first radiation arm extends;
a parasitic conductor connected with said ground plane and having a coupling side arranged along a contour of said coupling side of said feeder member, wherein said coupling side of said parasitic conductor and said coupling side of said feeder member have a gap therebetween; and
a feeder cable further comprising
a central cable connected with said feeder member, and
an outer cable connected with said ground plane.

2. The multi-frequency antenna according to claim 1, wherein said first radiation arm and said second radiation arm have an identical length.

3. The multi-frequency antenna according to claim 1, wherein said first radiation arm and said second radiation arm are used to excite a low-frequency resonant mode.

4. The multi-frequency antenna according to claim 1, wherein said parasitic conductor is used to excite a high-frequency resonant mode.

5. The multi-frequency antenna according to claim 1, wherein said parasitic conductor has a parallelogram shape.

6. The multi-frequency antenna according to claim 1, wherein said parasitic conductor has a rectangular shape.

7. The multi-frequency antenna according to claim 1, wherein said parasitic conductor has an irregular shape.
